(19) United States
(12) Patent Application Publication
(10) Pub. No.: US 2024/0403425 A1
(43) Pub. Date: Dec. 5, 2024

(54) FRAUD DETECTION APPARATUS, FRAUD DETECTION METHOD, AND FRAUD DETECTION PROGRAM

(71) Applicant: NEC Corporation, Minato- ku, Tokyo (JP)

(72) Inventors: Yusuke SHIMADA, Tokyo (JP); Nakul GHATE, Tokyo (JP); Kohei TATARA, Tokyo (JP)

(73) Assignee: NEC Corporation, Minato-ku, Tokyo (JP)

(21) Appl. No.: 18/698,056

(22) PCT Filed: Oct. 13, 2021
(86) PCT No.: PCT/JP2021/037817

§ 371 Date: Apr. 3, 2024

(51) Int. Cl. G06F 21/56; G06F 8/75; G06F 21/57

(52) U.S. Cl. CPC G06F 21/56; G06F 21/577; G06F 8/75; G06F 2221/033

(57) ABSTRACT

A fraud detection apparatus comprises: a function extraction part that refers to a target function list showing functions to be analyzed and analyzes a program to extract a target function; a structure extraction part that analyzes the program to extract an execution path and a conditional branch; a conditional branch scoring part that refers to a score list showing the probability of meeting the condition of a conditional branch and assigns a score to each of the extracted conditional branches to create a conditional branch score table; a reachability probability calculation part that calculates the probability of reaching the target function from the scores for conditional branches included in the execution path on the basis of the conditional branch score table; and a backdoor determination part that reports an execution path having a low reachability probability as a path with a high probability of being a backdoor execution path.

### TECHNICAL FIELD

The present invention relates to a fraud detection apparatus, fraud detection method, and fraud detection program.

### BACKGROUND ART

As one of measures for supply chain risk management, the detection of malicious functions within software, known as backdoors, has become increasingly important. Current computer systems have become so complex that it is difficult to configure them using only products from a single company. Therefore, it is common to procure parts externally and assemble the procured parts to configure a system. In this process, the manufacturers of the procured parts and the supply chains are assumed to be trustworthy because backdoor detection is also required as part of the process.

However, detecting backdoors in firmware requires significant time and effort without having the source code since such a task would entail reverse engineering, analyzing suspicious functions and execution paths in detail, and manually sifting them through to find backdoors. Therefore, there is a demand for computer-aided techniques in the tasks associated with backdoor detection (for instance, refer to Patent Literature 1).

### CITATION LIST

### Patent Literature

PATENT LITERATURE 1: WO2021/028989A

### SUMMARY

### Technical Problem

The disclosure of the literature in the above Citation List is incorporated herein in its entirety by reference thereto. The following analysis is given by the present inventors.

The functions that should be analyzed with caution are the ones that define as policies library functions and system calls, often used for backdoors. Even in the conventional technology, it is possible to identify within a program these functions and the execution paths that call them.

Regardless of the presence of backdoors, however, program execution paths often include functions defining library functions or system calls as policies. In the end, it is necessary for a human operator to manually analyze the execution paths in question and make a final decision. Therefore, there is a need for computer-assisted extraction of execution paths that are likely to be used for backdoors.

In view of the problem above, it is an object of the present invention to provide a fraud detection apparatus, fraud detection method, and fraud detection program that contribute to reducing the effort and time required from an operator.

### Solution to Problem

According to a first aspect of the present invention, there is provided a fraud detection apparatus comprising: a function extraction part that refers to a target function list showing functions to be analyzed and analyzes a supplied program to extract a target function to be analyzed; a structure extraction part that analyzes the program to extract an execution path and a conditional branch; a conditional branch scoring part that refers to a score list showing the probability of meeting the condition of a conditional branch and assigns a score to each of the extracted conditional branches to create a conditional branch score table; a reachability probability calculation part that calculates the probability of reaching the target function to be analyzed from the scores for conditional branches included in the execution path on the basis of the conditional branch score table; and a backdoor determination part that reports an execution path having a low reachability probability as a path with a high probability of being a backdoor execution path.

According to a second aspect of the present invention, there is provided a fraud detection method including: referring to a target function list showing functions to be analyzed and analyzing a supplied program to extract a target function to be analyzed; analyzing the program to extract an execution path and a conditional branch; referring to a score list showing the probability of meeting the condition of a conditional branch and assigning a score to each of the extracted conditional branches to create a conditional branch score table; calculating the probability of reaching the target function to be analyzed from the scores for conditional branches included in the execution path on the basis of the conditional branch score table; and reporting an execution path having a low reachability probability as a path with a high probability of being a backdoor execution path.

According to a third aspect of the present invention, there is provided a program causing a computer to execute: a process of referring to a target function list showing functions to be analyzed and analyzing a supplied program to extract a target function to be analyzed; a process of analyzing the program to extract an execution path and a conditional branch; a process of referring to a score list showing the probability of meeting the condition of a conditional branch and assigning a score to each of the extracted conditional branches to create a conditional branch score table; a process of calculating the probability of reaching the target function to be analyzed from the scores for conditional branches included in the execution path on the basis of the conditional branch score table; and a process of reporting an execution path having a low reachability probability as a path with a high probability of being a backdoor execution path. Further, this program can be stored in a computer-readable storage medium. The storage medium may be a non-transitory one such as a semiconductor memory, a hard disk, a magnetic recording medium, an optical recording medium, and the like. The present invention can also be realized as a computer program product.

### Advantageous Effects of Invention

According to each aspect of the present invention, it becomes possible to provide a fraud detection apparatus, fraud detection method, and fraud detection program that contribute to reducing the effort and time required from an operator.

### BRIEF DESCRIPTION OF DRAWINGS

FIG. 1 is a drawing showing a schematic configuration of a fraud detection apparatus relating to an example embodiment.

FIG. 2 is a drawing illustrating an example of a program tree.

FIG. 3 is a drawing illustrating an example of a program execution path.

FIG. 4 is a drawing showing an example of a score list.

FIG. 5 is a drawing showing an example of a conditional branch where the branched execution paths lead to the same analysis target function.

FIG. 6 is a schematic flowchart showing a fraud detection method relating to the example embodiment.

FIG. 7 is a drawing showing an example of the hardware configuration of the apparatus used in the example embodiment.

### EXAMPLE EMBODIMENTS

An example embodiment of the present invention will be described with reference to the drawings. The present invention, however, is not limited to the example embodiment described below. Further, in each drawing, the same or corresponding elements are appropriately designated by the same reference signs. It should also be noted that the drawings are schematic, and the dimensional relationships and the ratios between the elements may differ from the actual ones. The dimensional relationships and the ratios between drawings may also be different in some sections.

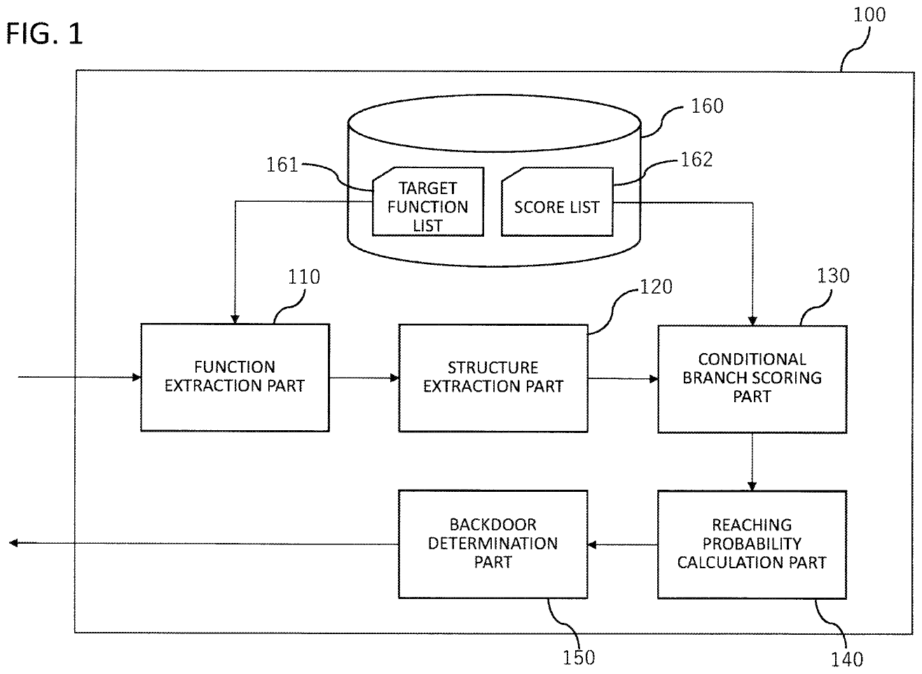

FIG. 1 is a drawing showing a schematic configuration of a fraud detection apparatus relating to the example embodiment. As shown in FIG. 1, the fraud detection apparatus 100 comprises a function extraction part 110, a structure extraction part 120, a conditional branch scoring part 130, a reachability probability calculation part 140, a backdoor determination part 150, and a storage device 160.

The function extraction part 110 refers to a target function list 161 showing functions to be analyzed, and analyzes a supplied program to extract a target function to be analyzed. The target function list 161 is stored in the storage device 160 and lists functions to be analyzed.

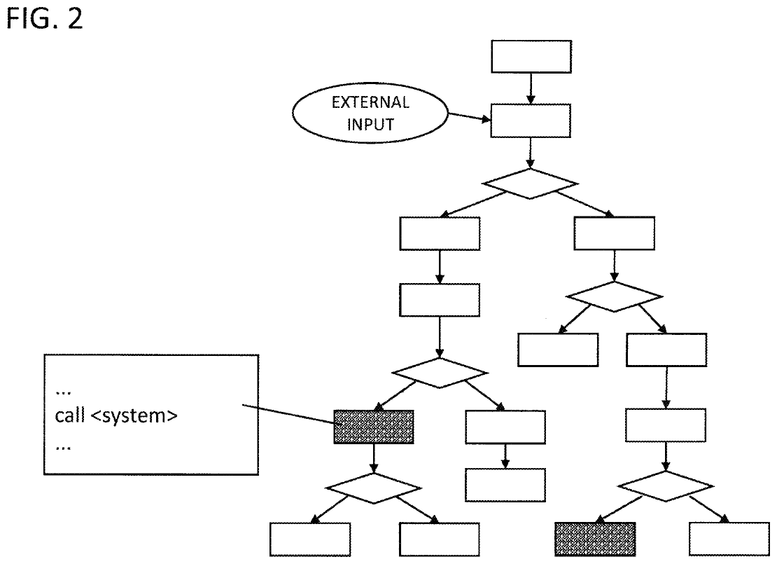

The target function list 161 shows functions to be analyzed, listed in advance, such as functions that have been recognized to require attention on the basis of preliminary analysis of function internals or call sites that call functions with sensitive impacts on the system. The function extraction part 110 analyzes a program as shown in FIG. 2, for instance, and extracts analysis target functions listed in the target function list 161. Note that, although not all execution paths include the functions listed in the target function list 161, an actual program has many such functions.

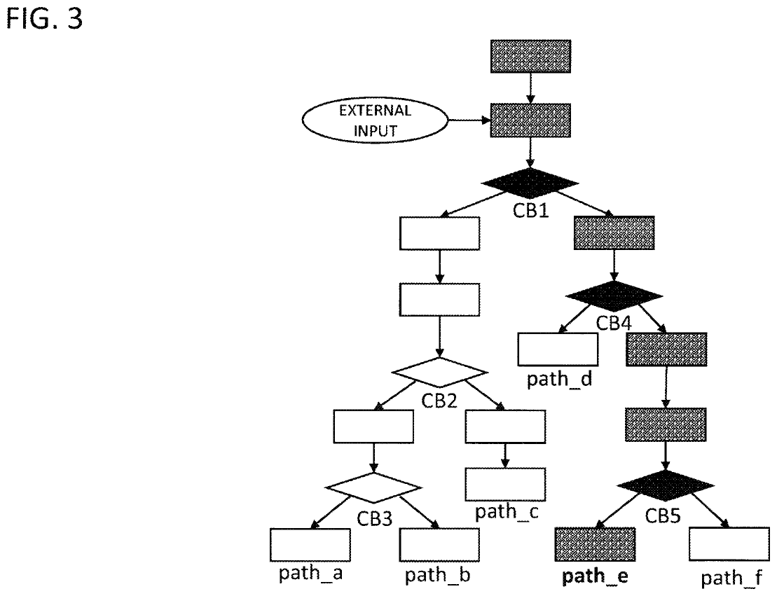

The structure extraction part 120 analyzes the program to extract an execution path and a conditional branch. For instance, the structure extraction part 120 creates a list of functions and conditional branches included in execution paths (path_a to path_f) in the program's tree, as shown in FIG. 3. An example of the created execution path list is shown below. In the example, an execution path EP #1 starts from funcA and concludes at funcX. [CB1, CB2] indicates the conditional branches present until funcA calls funcB.
EP #1: [funcA, [CB1, CB2], funcB, . . . , func X]
EP #n: [funcA, [CB3], funcC, [CB5, CB6] . . . , funcX]

The conditional branch scoring part 130 refers to a score list 162 that shows the probability of meeting the condition of a conditional branch and assigns a score to each conditional branch extracted from the program to create a conditional branch score table. The score list 162 is stored in the storage device 160 and shows the probability of meeting the condition of a conditional branch.

A conditional branch refers to a process where subsequent actions vary depending on whether or not a certain condition is met, and in a source code, the part that represents the condition of a conditional branch (such as an “if” statement) can take various expressions and values. For instance, a source code representation of a typical conditional branch is as follows:

void func_A(int param_1) {
...
If (cond) {
system(...);
...
}
...
}

Various conditional expressions are written in the “cond” part in the above example, and it is necessary to evaluate these various conditional expressions. Here are some examples of conditional expressions:
cond=(val==5)
cond=(char_c==‘a’)
cond=(strchr (header, 0x2f)!=0x0)
cond=((stream=fopen (“file.txt”, “r”))==NULL)
cond=(strcmp (username, “AAA”)==0)
cond=(strcmp (username, “AAA”)==0) && (strcmp (pass, “BBB”)==0)
cond=((ret=user_defined_funcA(params))==0)

The defined expressions “cond” listed above can be generalized as follows:
if (cond) { . . . }
“cond” is Boolean.
cond=CMP (x, y)
“cond” stores comparison results.

CMP can be given arguments of various variable types:
(int) val==5
(char) c==‘a’
((FILE) stream=fopen ( . . . ))!=NULL
(char *) username==“xxx” ((int)
ret=user_defined_func ( . . . ))>0

As shown above, there are various types of conditional branches, depending on the argument types. The conditional branch scoring part 130 refers to the score list 162 showing the probability of meeting the condition of a conditional branch to assign a score to each of these conditional branches.

At this time, the conditional branch scoring part 130 scores each conditional branch with a heuristic probability in order to quantitatively differentiate between conditional branches on system requirements checks and conditional branches based on special external input values.

The conditional branches based on system requirements checks involve checking the existence of a file, verifying the length of a structure element, and the like. For instance, such a conditional branch based on system requirements checks has its conditional expression typically defined with a pointer to a file, an integer type, etc.

On the other hand, the conditional branches based on special external input values involve a special string or consecutive comparison of specific byte values, which are often used as triggers for backdoors. Such a conditional branch based on special external input values has its conditional expression typically defined with a character type or string type.

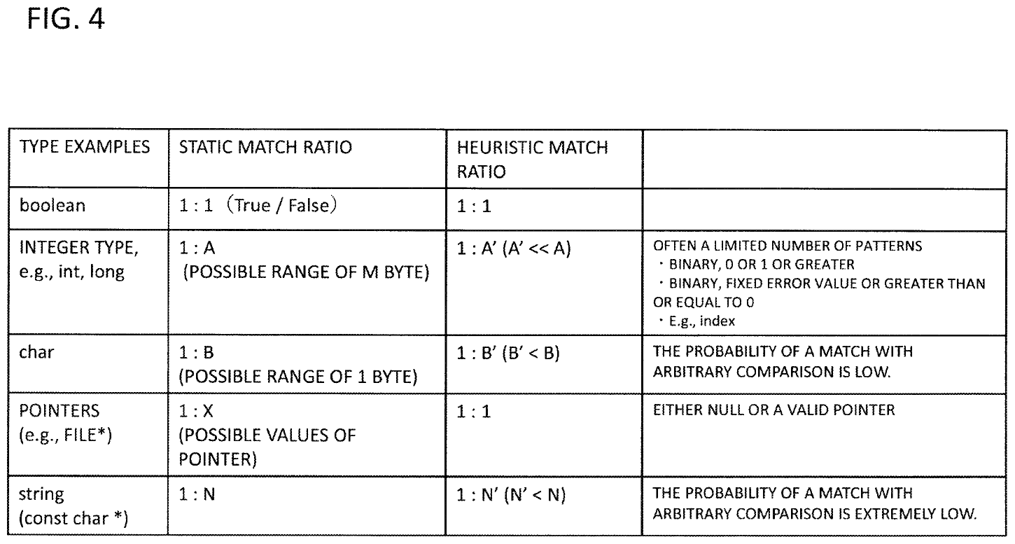

A table shown in FIG. 4 is an example of the score list 162 that heuristically defines the probabilities of satisfying various conditional branch conditions in accordance with the above policies.

As can be seen from the table shown in FIG. 4, the score list 162 sets the probability of being true in a conditional branch related to an integer type or a pointer to a file to 1 or a value close to 1. This is because checking the existence of a file or the length of a structure element is less commonly used as a backdoor trigger, as stated above.

In the case of a conditional expression involving an integer type, with the static match probability for random inputs considered, the probability of the condition being true is 1: A if we denote the range of possible values for M bytes as A. Here, the probability of the conditional expression being true is very low. Therefore, a value A′, significantly smaller than A, is used to set the probability of the conditional expression being true to a value close to 1 as a heuristic match probability. Further, in the case of a conditional expression involving a pointer, with the static match probability for random inputs considered, the probability of the condition being true is 1: X if we denote the range of possible values for the pointer as X. We, however, set the probability of the conditional expression being true to a value close to 1 as a heuristic match probability.

Meanwhile, as can be seen from the table shown in FIG. 4, the score list 162 sets the probability of being true in a conditional branch related to a character type or string type match to a small value. This is because a special string or consecutive comparison of specific byte values is often used as a backdoor trigger, as stated above.

In the case of a conditional expression involving a character type, with the static match probability for random inputs considered, the probability of the condition being true is 1: B if we denote the range of possible values for 1 byte as B. Here, the probability of the conditional expression being true is very low. Further, in the case of a conditional expression involving a string type, with the static match probability for random inputs considered, the probability of the conditional expression being true is very low. Since a special string or consecutive comparison of specific byte values is often used as a backdoor trigger, the heuristic match probability is set to a value that is not significantly different from the static match probability for random inputs.

The reason for quantitatively differentiating heuristic probabilities between conditional branches related to integer types or file pointers and those related to character type or string type matches as described above, is as follows:

A backdoor is triggered by input information known only to the attacker and follows the backdoor-specific execution paths. In other words, the probability that a random input will trigger a backdoor execution path is extremely low. To incorporate this knowledge, the probability of the condition being true in a conditional branch related to a character type or string type is set to be lower than the static match probability for a random input.

Here are some examples of probabilities of conditional branches being true:

Example 1: The probability of the following conditional branch being satisfied is high (½).
if ((stream=fopen (“myfile.dat”, “r”))!=NULL) { . . . }

Example 2: The probability of the following conditional branch being satisfied is relatively high.

int index = 0;
while (1) {
if (index == 100) {...}
}

Example 3: The probability of the following conditional branch being satisfied is relatively low.
if (c==‘0x3f’) { . . . }

Example 4: The probability of the following conditional branch being satisfied is low.
if (strcmp(name, “xxx”)==0) { . . . }

The heuristic probability for the conditional expression of a conditional branch including “AND” is determined by multiplying each individual probability, whereas each of the probabilities are summed for a conditional expression including “OR.”

### Example 5

if ((strcmp(user, “AAA”) == 0) && (strcmp(pass, “BBB”) == 0)) {
iVar5 = funcA(...);
}

In this case, when the probability of (strcmp (user, “AAA”)==0) is P(CB1) and the probability of (strcmp (pass, “BBB”)==0) is P(CB2), the overall probability is P(CB1)*P(CB2).

### Example 6

if ((char_a == ‘0x3f) ∥ (char_b == ‘0x6d’)) {
iVar5 = funcA(...);
}

In this case, when the probability of (char_a==‘0x3f) is P(CB1) and the probability of “(char_b==‘0x6d’)” is P(CB2), the overall probability is P(CB1)+P(CB2).

As described, the conditional branch scoring part 130 assigns a score to each conditional branch extracted from the program. The conditional branch score table is created as a result. The table below is an example of the conditional branch score table:

TABLE 1

| Conditional | Heuristic probability assigned to |
|---|---|
| branch | conditional branch |
| CB1 | P(CB1) |
| CB2 | P(CB2) |
| . . . | . . . |
| CBn | P(CBn) |

On the basis of such a conditional branch score table, the reachability probability calculation part 140 calculates the probability of reaching an analysis target function from the scores for conditional branches included in an execution path.

The structure extraction part 120 creates a list of execution paths as shown below. The reachability probability calculation part 140 assigns the scores (heuristic probabilities) listed in the conditional branch score table as shown above to conditional branches included in an execution path and then calculates the reachability probability by multiplying these scores.

Execution path list:
EP #1: [funcA, [CB1, CB2], funcB, . . . , funcX]
EP #n: [funcA, [CB3], funcC, [CB5, CB6] . . . , funcX]

Since an execution path EP #1 includes conditional branches CB1 and CB2, the reachability probability is P(CB1)*P(CB2). Further, since an execution path EP #n includes conditional branches CB3, CB5, and CB6, the reachability probability is P(CB3)*P(CB5)*P(CB6).

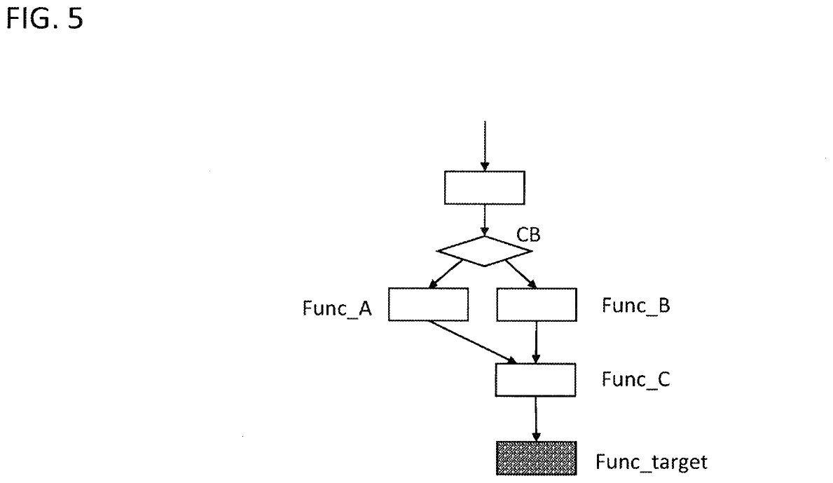

Note that the reachability probability is calculated excluding a conditional branch (or branches) within the execution path where the branched execution paths lead to the same analysis target function. For instance, FIG. 5 shows a conditional branch where the branched execution paths lead to the same analysis target function. The conditional branch CB shown in FIG. 5 executes either a function Func_A or a function Func_B depending on the truth value of the conditional expression; however, both execution paths ultimately lead to the same analysis target function Func_target. In such a case, the reachability probability is calculated excluding the conditional branch CB. If the probability of the conditional branch CB being true is P(CB), then the probability of it being false is 1−P(CB). Since, regardless of whether it is true or false, the path will lead to the analysis target function, this is the same as assigning P(CB)+(1−P(CB))=1 to the conditional branch CB as a probability score.

The backdoor determination part 150 repots an execution path having a low reachability probability, calculated as described, as a path with a high probability of being a backdoor execution path. The notification recipient may be, for instance, an operator performing backdoor detection tasks. It is also possible to output the notification to another apparatus or program.

Execution paths with low reachability probabilities are likely to be backdoor execution paths because backdoors are triggered by input information known only to the attacker and the probability of triggering a backdoor execution path with a random input is extremely low, as stated above. Further, in the calculation of reachability probabilities described above, the probability of the condition being true in a conditional branch related to a character type or string type match is set to be lower than the static match probability for a random input. This allows for a more effective estimation of backdoor execution paths than an estimation assuming random inputs.

The backdoor determination part 150 determines that an execution path having a reachability probability equal to or less than a threshold value is likely to be a backdoor execution path. At this time, it is preferred that the threshold value be determined according to the number of conditional branches included in the program. This is because, as the number of conditional branches included in a program increases, the reachability probability for each execution path decreases.

### (Fraud Detection Method)

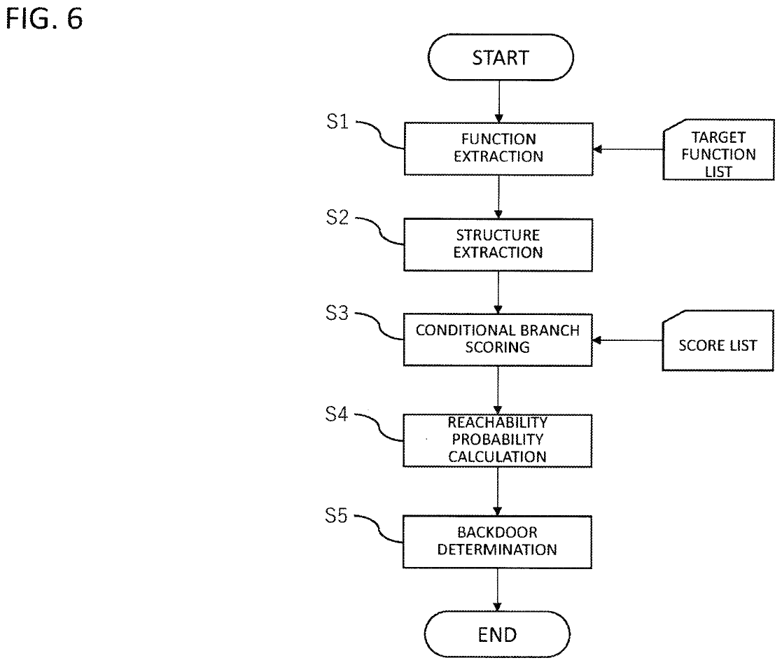

FIG. 6 is a schematic flowchart showing a fraud detection method relating to the example embodiment. As shown in FIG. 6, the fraud detection method has a function extraction step (step S1), a structure extraction step (step S2), a conditional branch scoring step (step S3), a reachability probability calculation step (step S4), and a backdoor determination step (step S5).

The function extraction step (the step S1) refers to a target function list showing functions to be analyzed and analyzes a supplied program to extract a target function to be analyzed. As already explained, the target function list shows functions to be analyzed, listed in advance, such as functions that have been recognized to require attention on the basis of preliminary analysis of function internals or call sites that call functions with sensitive impacts on the system. The function extraction step (the step S1) analyzes the supplied program and extracts analysis target functions listed in the target function list.

The structure extraction step (the step S2) analyzes the program to extract an execution path and a conditional branch. The structure extraction step (the step S2) creates a list of functions and conditional branches included in execution paths in the program's tree,

The conditional branch scoring step (the step S3) refers to a score list that shows the probability of meeting the condition of a conditional branch and assigns a score to each conditional branch extracted from the program to create a conditional branch score table. The score list shows the probability of meeting the condition of a conditional branch.

The reachability probability calculation step (the step S4) calculates the probability of reaching an analysis target function from the score for each of conditional branches included in an execution path on the basis of the conditional branch score table. A list of execution paths was created in the structure extraction step (the step S2). Then, the reachability probability calculation step (the step S4) assigns the scores (heuristic probabilities) listed in the conditional branch score table to conditional branches included in an execution path and then calculates the reachability probability by multiplying these scores.

The backdoor determination step (the step S5) reports an execution path having a low reachability probability, calculated in the reachability probability calculation step (the step S4), as a path with a high probability of being a backdoor execution path. The backdoor determination step (the step S5) determines that an execution path having a reachability probability equal to or less than a threshold value is likely to be a backdoor execution path. At this time, it is preferred that the threshold value be determined according to the number of conditional branches included in the program.

As described above, the present invention may also be implemented as a fraud detection method.

### (Hardware Configuration)

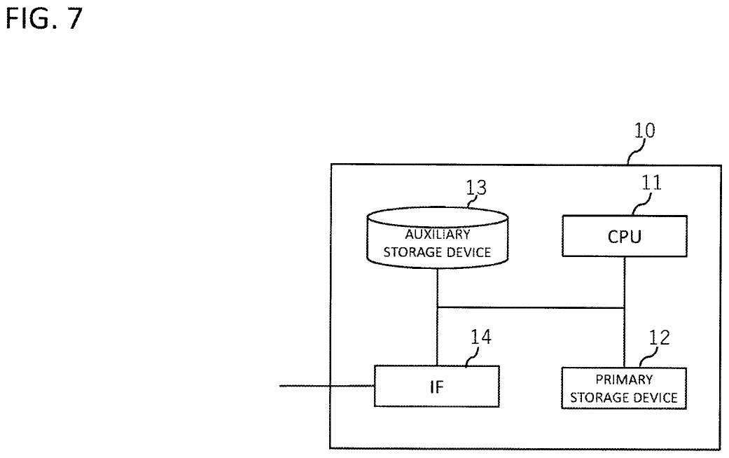

FIG. 7 is a drawing showing an example of the hardware configuration of the apparatus used in the example embodiment. In other words, the fraud detection apparatus 100 is able to achieve the functions thereof by causing an information processing apparatus (computer) 10 employing the hardware configuration shown in FIG. 7 to execute the fraud detection method described above as a program. It should be noted that the hardware configuration example shown in FIG. 7 is merely an example of the hardware configuration that achieves the functions of the fraud detection apparatus 100 and is not intended to limit the hardware configuration of the fraud detection apparatus 100. The fraud detection apparatus 100 may include hardware not shown in FIG. 7.

As shown in FIG. 7, the hardware configuration 10 that may be employed by the fraud detection apparatus 100 comprises a CPU (Central Processing Unit) 11, a primary storage device 12, an auxiliary storage device 13, and an IF (interface) part 14, which are connected to each other by, for instance, an internal bus.

The CPU 11 executes each instruction included in the fraud detection program executed by the information processing apparatus (computer) 10. The primary storage device 12 is, for instance, a RAM (Random Access Memory) and temporarily stores various programs such as the fraud detection program executed by the information processing apparatus (computer) 10 so that the CPU 11 can process the programs.

The auxiliary storage device 13 is, for instance, an HDD (Hard Disk Drive) and is capable of storing the various programs, such as the fraud detection program executed by the information processing apparatus (computer) 10, in the medium to long term. The various programs such as the fraud detection program may be provided as a program product stored in a non-transitory computer-readable storage medium.

The IF part 14 provides an interface related to, for instance, the input and output of the fraud detection apparatus 100.

The information processing apparatus (computer) 10 employing the hardware configuration described above achieves the functions of the fraud detection apparatus 100 by executing the fraud detection method described above as a program.

A part of or the entire example embodiment above can be described as (but not limited to) the following Supplementary Notes.

### Supplementary Note 1

A fraud detection apparatus comprising:
a function extraction part that refers to a target function list showing functions to be analyzed and analyzes a supplied program to extract a target function to be analyzed;
a structure extraction part that analyzes the program to extract an execution path and a conditional branch;
a conditional branch scoring part that refers to a score list showing the probability of meeting the condition of a conditional branch and assigns a score to each of the extracted conditional branches to create a conditional branch score table;
a reachability probability calculation part that calculates the probability of reaching the target function to be analyzed from the scores for conditional branches included in the execution path on the basis of the conditional branch score table; and
a backdoor determination part that reports an execution path having a low reachability probability as a path with a high probability of being a backdoor execution path.

### Supplementary Note 2

The fraud detection apparatus according to Supplementary Note 1, wherein the probabilities listed in the score list are heuristic probabilities that quantitatively distinguish conditional branches based on special external input values.

### Supplementary Note 3

The fraud detection apparatus according to Supplementary Note 2, wherein the score list sets the probability of being true in a conditional branch related to a character type or string type match to a small value.

### Supplementary Note 4

The fraud detection apparatus according to Supplementary Note 2 or 3, wherein the score list sets the probability of being true in a conditional branch related to an integer type or a pointer to a file to 1 or a value close to 1.

### Supplementary Note 5

The fraud detection apparatus according to any one of Supplementary Notes 1 to 4, wherein the probability of reaching the target function to be analyzed is calculated by multiplying the scores for conditional branches included in the execution path.

### Supplementary Note 6

The fraud detection apparatus according to Supplementary Note 5, wherein the probability of reaching the target function to be analyzed is calculated excluding a conditional branch (or branches) within the execution path where branched execution paths lead to the same target function to be analyzed.

### Supplementary Note 7

The fraud detection apparatus according to any one of Supplementary Notes 1 to 6, wherein the backdoor determination part reports an execution path having a reachability probability equal to or less than a threshold value.

### Supplementary Note 8

The fraud detection apparatus according to Supplementary Note 7, wherein the threshold value is determined according to the number of conditional branches included in the program.

### Supplementary Note 9

A fraud detection method including:
referring to a target function list showing functions to be analyzed and analyzing a supplied program to extract a target function to be analyzed;
analyzing the program to extract an execution path and a conditional branch;
referring to a score list showing the probability of meeting the condition of a conditional branch and assigning a score to each of the extracted conditional branches to create a conditional branch score table; calculating the probability of reaching the target function to be analyzed from the scores for conditional branches included in the execution path on the basis of the conditional branch score table; and
reporting an execution path having a low reachability probability as a path with a high probability of being a backdoor execution path.

### Supplementary Note 10

A program causing a computer to execute:
a process of referring to a target function list showing functions to be analyzed and analyzing a supplied program to extract a target function to be analyzed;
a process of analyzing the program to extract an execution path and a conditional branch;
a process of referring to a score list showing the probability of meeting the condition of a conditional branch and assigning a score to each of the extracted conditional branches to create a conditional branch score table;
a process of calculating the probability of reaching the target function to be analyzed from the scores for conditional branches included in the execution path on the basis of the conditional branch score table; and
a process of reporting an execution path having a low reachability probability as a path with a high probability of being a backdoor execution path.

Further, the disclosure of Patent Literature cited above is incorporated herein in its entirety by reference thereto. It is to be noted that it is possible to modify or adjust the example embodiments or examples within the scope of the whole disclosure of the present invention (including the Claims) and based on the basic technical concept thereof. Further, it is possible to variously combine or select (or partially omit) a wide variety of the disclosed elements (including the individual elements of the individual claims, the individual elements of the individual example embodiments or examples, and the individual elements of the individual figures) within the scope of the whole disclosure of the present invention. That is, it is self-explanatory that the present invention includes any types of variations and modifications to be done by a skilled person according to the whole disclosure including the Claims and the technical concept of the present invention.

Particularly, any numerical ranges disclosed herein should be interpreted that any intermediate values or subranges falling within the disclosed ranges are also concretely disclosed even without specific recital thereof. In addition, using some or all of the disclosed matters in the literatures cited above as necessary, in combination with the matters described herein, as part of the disclosure of the present invention in accordance with the object thereof shall be considered to be included in the disclosed matters of the present application.

### REFERENCE SIGNS LIST

100: fraud detection apparatus
110: function extraction part
120: structure extraction part
130: conditional branch scoring part
140: reachability probability calculation part
150: backdoor determination part
10: information processing apparatus (computer)
11: CPU
12: primary storage device
13: auxiliary storage device
14: IF part

What is claimed is:

1. A fraud detection apparatus comprising:
a function extraction part that refers to a target function list showing functions to be analyzed and analyzes a supplied program to extract a target function to be analyzed;
a structure extraction part that analyzes the program to extract an execution path and a conditional branch;
a conditional branch scoring part that refers to a score list showing the probability of meeting the condition of a conditional branch and assigns a score to each of the extracted conditional branches to create a conditional branch score table;
a reachability probability calculation part that calculates the probability of reaching the target function to be analyzed from the scores for conditional branches included in the execution path on the basis of the conditional branch score table; and
a backdoor determination part that reports an execution path having a low reachability probability as a path with a high probability of being a backdoor execution path.

2. The fraud detection apparatus according to claim 1, wherein the probabilities listed in the score list are heuristic probabilities that quantitatively distinguish conditional branches based on special external input values.

3. The fraud detection apparatus according to claim 2, wherein the score list sets the probability of being true in a conditional branch related to a character type or string type match to a small value.

4. The fraud detection apparatus according to claim 2, wherein the score list sets the probability of being true in a conditional branch related to an integer type or a pointer to a file to 1 or a value close to 1.

5. The fraud detection apparatus according to claim 1, wherein the probability of reaching the target function to be analyzed is calculated by multiplying the scores for conditional branches included in the execution path.

6. The fraud detection apparatus according to claim 5, wherein the probability of reaching the target function to be analyzed is calculated excluding a conditional branch within the execution path where branched execution paths lead to the same target function to be analyzed.

7. The fraud detection apparatus according to claim 1, wherein the backdoor determination part reports an execution path having a reachability probability equal to or less than a threshold value.

8. The fraud detection apparatus according to claim 7, wherein the threshold value is determined according to the number of conditional branches included in the program.

9. A fraud detection method including:
referring to a target function list showing functions to be analyzed and analyzing a supplied program to extract a target function to be analyzed;
analyzing the program to extract an execution path and a conditional branch;
referring to a score list showing the probability of meeting the condition of a conditional branch and assigning a score to each of the extracted conditional branches to create a conditional branch score table;
calculating the probability of reaching the target function to be analyzed from the scores for conditional branches included in the execution path on the basis of the conditional branch score table; and
reporting an execution path having a low reachability probability as a path with a high probability of being a backdoor execution path.

10. A non-transitory computer readable medium storing a program causing a computer to execute:
a process of referring to a target function list showing functions to be analyzed and analyzing a supplied program to extract a target function to be analyzed;
a process of analyzing the program to extract an execution path and a conditional branch;
a process of referring to a score list showing the probability of meeting the condition of a conditional branch and assigning a score to each of the extracted conditional branches to create a conditional branch score table;
a process of calculating the probability of reaching the target function to be analyzed from the scores for conditional branches included in the execution path on the basis of the conditional branch score table; and
a process of reporting an execution path having a low reachability probability as a path with a high probability of being a backdoor execution path.

11. The fraud detection method according to claim 9, wherein the probabilities listed in the score list are heuristic probabilities that quantitatively distinguish conditional branches based on special external input values.

12. The fraud detection method according to claim 11, wherein the score list sets the probability of being true in a conditional branch related to a character type or string type match to a small value.

13. The fraud detection method according to claim 11, wherein the score list sets the probability of being true in a conditional branch related to an integer type or a pointer to a file to 1 or a value close to 1.

14. The fraud detection method according to claim 9, wherein the probability of reaching the target function to be analyzed is calculated by multiplying the scores for conditional branches included in the execution path.

15. The fraud detection method according to claim 14, wherein the probability of reaching the target function to be analyzed is calculated excluding a conditional branch within the execution path where branched execution paths lead to the same target function to be analyzed.

16. The non-transitory computer readable medium storing the program according to claim 10, wherein the probabilities listed in the score list are heuristic probabilities that quantitatively distinguish conditional branches based on special external input values.

17. The non-transitory computer readable medium storing the program according to claim 16, wherein the score list sets the probability of being true in a conditional branch related to a character type or string type match to a small value.

18. The non-transitory computer readable medium storing the program according to claim 16, wherein the score list sets the probability of being true in a conditional branch related to an integer type or a pointer to a file to 1 or a value close to 1.

19. The non-transitory computer readable medium storing the program according to claim 10, wherein the probability of reaching the target function to be analyzed is calculated by multiplying the scores for conditional branches included in the execution path.

20. The non-transitory computer readable medium storing the program according to claim 19, wherein the probability of reaching the target function to be analyzed is calculated excluding a conditional branch within the execution path where branched execution paths lead to the same target function to be analyzed.
